(19) United States
(12) Patent Application Publication
(10) Pub. No.: US 2010/0181908 A1
(43) Pub. Date: Jul. 22, 2010

(54) FLAT DISPLAY

(75) Inventors: Koji Akiyama, Osaka (JP); Masaki Nishinaka, Osaka (JP); Akinobu Miyazaki, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 12/063,051

(22) PCT Filed: Feb. 26, 2007
(86) PCT No.: PCT/US2007/053505

§ 371 Date: Feb. 6, 2008

(30) Foreign Application Priority Data
Feb. 28, 2006 (JP) JP 2006-051733

(51) Int. Cl. H01J 17/49; H01J 61/35

(52) U.S. Cl. 313/582; 313/635

(57) ABSTRACT

Disclosed here is a flat display having a pair of glass substrates and a sealing member applied on the periphery of the glass substrates. The glass substrates are oppositely disposed to each other at intervals therebetween. The glass substrates contain silicon as a component, while the sealing member contains bismuth. A protection layer and an insulating layer as an intermediate layer, which has a silicon-content lower than the glass substrates, are formed on the interface between the glass substrates and the sealing member. The structure above reinforces bonding strength of the sealing section, providing a highly reliable flat display.

### TECHNICAL FIELD

The present invention relates to a flat display, such as a field emission display (hereinafter referred to as FED) and a plasma display panel (hereinafter, PDP).

### BACKGROUND ART

In general, frit glass is used as an adhesive for bonding inorganic material, such as glass, ceramics and metal. When the frit glass is used as a sealing member of FEDs and PDPs in which a panel is formed of two glass substrates bonded with each other, a firm bonding-strength is required of the frit glass. This is because the inside the panel of an FED or a PDP has to be kept in conditions of reduced pressure or high vacuum. Frit glass seals the periphery of the panel to avoid entry of outside air into inside the panel. When the panel suffers vibration or drop impact during transport, poor bonding-strength of frit glass can cause a crack between the frit glass and the glass substrates. Through the crack, outside air comes into the interior of the panel, causing lighting failure in a partial area—in the entire area, at worst—of the panel. In the case of FEDs where the inside of the panel is kept under high vacuum, the worst case often results.

Hereinafter, the structure of a PDP as a flat display will be described. A PDP has a front substrate and a back substrate.

The front substrate contains the following components:
a glass substrate made of sodium borosilicate glass by a float method;
display electrodes having transparent electrodes and bus electrodes arranged in stripes on one principal plane of the glass substrate;
a dielectric layer that is disposed over the display electrodes and serves as a capacitor; and
a protection layer that is made of magnesium oxide (MgO) and is disposed over the dielectric layer.

On the other hand, the back substrate contains the following components:
a glass substrate;
data electrodes arranged in stripes on one principal plane of the glass substrate;
an insulating layer disposed over the data electrodes;
barrier ribs, which are formed on the insulating layer, divides a discharge space into a plurality of discharge cells; and
phosphor layers, which are formed between the barrier ribs, emit light in red, green and blue.

The front substrate and the back substrate are located with the electrode⁻formed planes of each substrate disposed in face-to-face arrangement.

The two substrates are hermetically sealed on the periphery with a sealing member. After that, the discharge space, which is divided by the barrier ribs, is filled with a discharge gas of Ne—Xe with a charge pressure ranging from 53 kPa to 80 kPa (i.e., from 400 Torr to 600 Torr). Through the process above, the panel is completed.

In a PDP with the structure above, selective application of image signal voltage to the display electrodes causes discharge. The discharge generates ultraviolet light, which excites the phosphor layers responsible for emitting red, green and blue. This allows the panel to provide full color display.

The materials constituting a PDP are mainly formed of glasses with a low melting point. To form these materials, printing and firing processes are repeatedly carried out. Because of repeated cycles of printing and firing, the materials used in later processes have to be formed of glasses with lower softening point than that in former processes. That is, when such materials are formed one after another, there is a need to control a softening point of each material in a broad range of temperature. Among the glasses with a low melting point, lead glass is a material that offers an easy control of softening point. This is why the lead glass has been popularly used for PDPs.

In recent years, however, under growing concern about environmental protection, studies show that lead is hazardous to human and environment. Manufacturers have perceived these as problems and sought substitutes for lead glass. Frit glass, which is a sealing material used in the final process of manufacturing PDPs, has the lowest softening point; and accordingly, high in lead content. Under the circumstances, development of lead-free frit glass has become necessary. Japanese Patent Unexamined Publication No. 2004-238273 discloses a bismuth (Bi)-based glass composition as a lead-free material. However, a problem has occurred in using Bi-based frit glass as the sealing member of PDPs; Bi-based frit glass can cause a crack between the frit glass and the glass substrates in the drop impact.

### SUMMARY OF THE INVENTION

The flat display of the present invention has a pair of glass substrates oppositely disposed at intervals and a sealing member disposed on the periphery of the glass substrates. The glass substrates contain silicon, whereas the sealing member contains bismuth. The flat display contains an intermediate layer disposed at the interface between the glass substrates and the sealing member. The intermediate layer has a silicon-content lower than the glass substrates.

Having the structure above, the flat display offers high strength in the sealing section and therefore offers highly reliable performance.

### BRIEF DESCRIPTION OF THE DRAWINGS

FIG. 1 is a perspective view showing the structure of a PDP as a flat display in accordance with a first exemplary embodiment of the present invention.

FIG. 2 is a perspective view showing an appearance of the PDP as a flat display in accordance with the first exemplary embodiment.

FIG. 3 is a section view showing the essential part of the structure of the PDP as a flat display in accordance with the first exemplary embodiment.

FIG. 4 is a section view showing the essential part of the structure of a PDP as a flat display in accordance with a second exemplary embodiment.

FIG. 5 is a section view showing the essential part of the structure of a PDP as a flat display in accordance with a third exemplary embodiment.

FIG. 6 is a section view showing the essential part of the structure of a PDP as a flat display in accordance with a fourth exemplary embodiment.

FIG. 7 is a section view showing the essential part of another structure of a PDP as a flat display in accordance with the fourth exemplary embodiment.

FIG. 8 is a section view showing the essential part of still another structure of a PDP as a flat display in accordance with the fourth exemplary embodiment.

FIG. 9 is a perspective view showing an appearance of a display device using an electron-emitting element as a flat display in accordance with a fifth exemplary embodiment.

FIG. 10 is a section view showing the essential part of the structure of the display device using an electron-emitting element as a flat display in accordance with the fifth exemplary embodiment.

### REFERENCE MARKS IN THE DRAWINGS

1, 21 front substrate

2, 22 back substrate

4, 24, 27, 90 glass substrate

5 scan electrode

6 sustain electrode

7 dielectric layer

9 shielding layer

11 insulating layer

12 data electrode

13 barrier rib

14, 26 phosphor layer

15, 30 peripheral section

16, 33 sealing member

25 anode electrode

28 cathode electrode

29 electron-emitting element array

31 sealing section

32 frame

34 intermediate layer

93 discharge space

98 protection layer

### DETAILED DESCRIPTION OF THE PREFERRED EMBODIMENTS

The exemplary embodiments of the present invention are described hereinafter with reference to the accompanying drawings.

### First Exemplary Embodiment

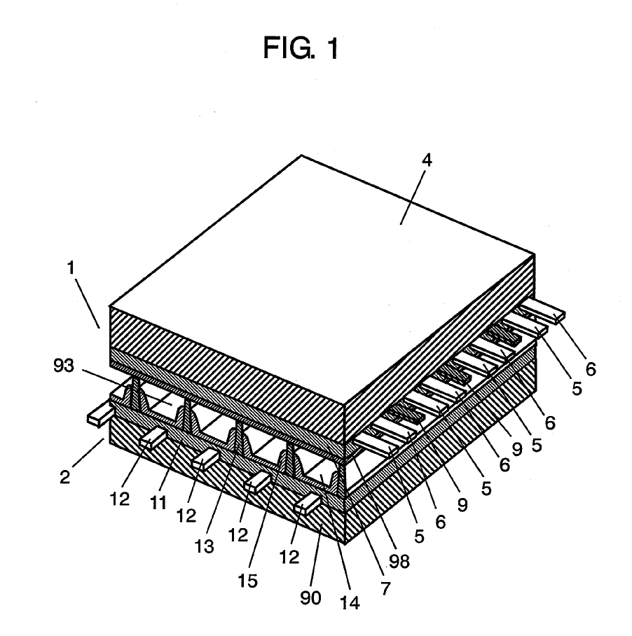

A flat display of the first exemplary embodiment is described hereinafter with reference to FIGS. 1 through 3. The description of the embodiment will be made on a PDP as an example of flat displays.

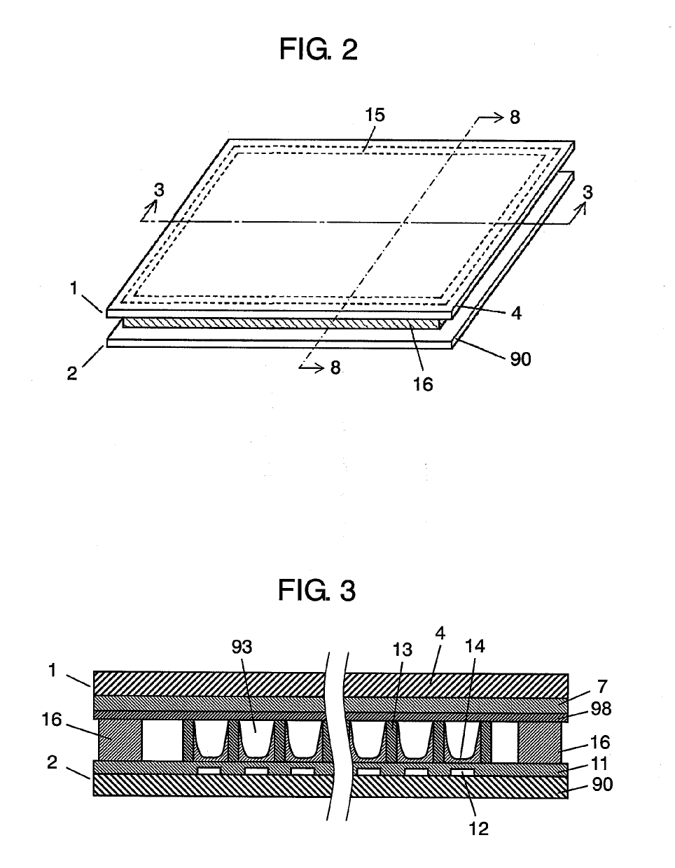

FIG. 1 and FIG. 2 are perspective views of a PDP; the former shows the structure of the PDP, and the latter shows its appearance. FIG. 3 is a section view taken along the line 3-3 in FIG. 2, which shows the essential part of the PDP. As is shown in FIG. 1, the PDP contains a pair of glass-made substrates (i.e., front substrate 1 and back substrate 2). The two substrates are oppositely disposed at intervals so as to form discharge space 93 therebetween.

Front substrate 1 has glass substrate 4 and a plurality of display electrodes on glass substrate 4. Each of the display electrodes is formed of pairs of scan electrodes 5 and sustain electrodes 6 in parallel with each other. Scan electrodes 5 and sustain electrodes 6 are generally formed of a combination of a transparent conductive film and a bus electrode film that carries electricity to the transparent conductive film. As for the transparent conductive film, an indium tin oxide (ITO)-film and a tin oxide (SnO₂)-film are employed. As for the bus electrode film, a silver-made film and a film with three-layered structure of Cr/Cu/Cr are employed.

Scan electrodes 5 and sustain electrodes 6 are covered with dielectric layer 7 that is disposed almost over glass substrate 4. Dielectric layer 7 is further covered with protection layer 98. Dielectric layer 7 has a thickness ranging from 30 μm to 50 μm, and protection layer 98 has a thickness ranging from 0.5 μm to 2 μm. Dielectric layer 7 is formed through the process below: preparing paste including dielectric glass-powder (where, the paste is typically formed of bismuth-based material [Bi—Zn—B—Si—O], zinc/boric-acid-based material [Zn—B—Si—O] and lead-based material [Pb—B—Si—O]); coating the paste on glass substrate 4 by printing and then firing it. Protection layer 98 is made of a multi-crystal magnesium oxide (MgO) film that is resistant to sputtering to protect dielectric layer 7 from damage caused by discharge. Protection layer 98 is formed by commonly used thin-film forming methods, such as electron beam deposition, chemical vapor deposition (CVD) and sputtering.

Front substrate 1 further contains black shielding layer 9 between the display electrodes formed of scan electrodes 5 and sustain electrodes 6.

On the other hand, back substrate 2 has glass substrate 90 and a plurality of data electrodes 12 formed on glass substrate 90. Data electrodes 12 are covered with insulating layer 11 that is disposed almost all over glass substrate 90. Barrier ribs 13 are formed into stripes or a grid on insulating layer 11 to divide discharge space 93 into a plurality of discharge cells. Insulating layer 11 has a thickness ranging from 5 μm to 20 μm. Insulating layer 11 is formed of a material and by a process similar to those of dielectric layer 7 of front substrate 1. Phosphor layer 14, which is responsible for emitting three colors (red, green and blue) for full color display, is disposed on the surface of insulating layer 11 and on the side surface of barrier ribs 13.

Such structured front substrate 1 and back substrate 2 are oppositely located via discharge space 93 in a manner that the display electrodes (i.e., scan electrodes 5 and sustain electrodes 6) and data electrodes 12 are placed in an orthogonal arrangement. Discharge space 93 is sealed with sealing member 16 formed on peripheral section 15 of front substrate 1 and back substrate 2. Discharge space 93 is filled with discharge gas, for example, a gas mixture of neon (Ne) and xenon (Xe). A PDP is thus completed.

Discharge space 93 is sealed with sealing member 16 through the following steps: mixing glass frit powder that contains bismuth (Bi) as a main component, resin and a solvent to prepare paste; applying the paste to peripheral section 15 of front substrate 1 or back substrate 2 by screen printing or an injection method; heating the paste until a temperature that melts away resin and putting together the two substrates; and bonding the two substrates by heating the paste on peripheral section 15 until a temperature that softens the glass powder.

Acrylic resin, ethylcellulose and nitrocellulose are employed for the resin used for the paste of sealing member 16. Isoamyl acetate, terpineol are employed for the solvent.

The Bi-content of sealing member 16 should preferably be determined between 50 wt % and 80 wt %. This is because of the constraint described earlier—a member to be formed in later stage of the manufacturing process has no ill effect on a member formed in earlier stage of the process. Other than Bi, sealing member 16 contains silicon (Si) and oxygen (O) to maintain characteristics as glass, and further contains boron (B), zinc (Zn), aluminum (Al). In addition, to increase strength of itself, sealing member 16 contains ceramic powder and glass with a high softening point formed of Al—Si—Mg—O-based material, which is known as filler. Such a filler is included in sealing member 16 in a range of 5 wt % to 20 wt %.

According to the structure of the embodiment, an intermediate layer is disposed at an interface between glass substrate 4 of front substrate 1 and sealing member 16, and an interface between glass substrate 90 of back substrate 2 and sealing member 16. The intermediate layer has a silicon-content lower than glass substrates 4 and 90. Specifically, as shown in FIG. 3, dielectric layer 7 and protection layer 98, as the intermediate layer, are disposed at an interface between glass substrate 4 and sealing member 16. Dielectric layer 7 is made of glass with a low melting point, and protection layer 98 is made of a crystalline oxide film. On the other hand, insulating layer 11, as the intermediate layer is disposed at an interface between glass substrate 90 and sealing member 16. Insulating layer 11 is made of glass with a low melting point. The intermediate layer is formed on all over glass substrates 4 and 90.

Next will be described the effect obtained by the PDP as a flat display of the first exemplary embodiment.

The inventor prepared a PDP having the structure of the embodiment and a comparative PDP where sealing member 16 makes directly contact with glass substrates 4 and 90. After being packed, the two PDPs underwent a drop impact test. The test samples were prepared more than 30 for each.

The result of the test showed that sealing member 16 of the PDP of the embodiment had no problem. In the comparative PDP, however, some samples had a crack between sealing member 16 and glass substrate 4, 90.

To track down the cause of difference in strength between the two PDPs, the inventor observed each section of the interface between sealing member 16 and glass substrates 4, 90 by a transmission electron microscope (TEM). At the same time, the inventor performed analyses on composition of sealing member 16 by an energy dispersive X-ray spectroscopy (EDS) method. According to the observation result of the PDP of the embodiment, dispersion of Si into sealing member 16 was not found at the interface between sealing member 16 and protection layer 98; on the other hand, at the interface between sealing member 16 and insulating layer 11, the Si-dispersion was observed no more than 10 nm. In contrast, in the observation result of the comparative PDP, Si contained in glass substrates 4 and 90 has dispersed into sealing member 16 as deep as 100 nm from each section of the interface between sealing member 16 and glass substrates 4, 90.

Studying the result above, the inventor has a view that the following contributes to decrease in strength of sealing member 16 in the comparative PDP. As the Si-dispersion into Bi-contained sealing member 16 increases, sealing member 16 is prone to get harder. That is, the inventor makes the inference that sealing member 16 disposed around the interface, due to increased Si-content on the interface and the adjacent area, becomes harder and therefore brittle. In other words, protecting sealing member 16 from Si-dispersion is critical to enhancing reliability of sealing member 16 that contains Bi.

According to the PDP of the first exemplary embodiment, protection layer 98 serves as an intermediate layer with a low Si-content. Even in the case where Si is added as dopant to control electron emission characteristic of MgO, the Si-content of protection layer 98 does not go beyond 1%. The Si-content of protection layer 98 is so low that sealing member 16 has no Si-dispersion from protection layer 98. Similarly, insulating layer 11—although it contains Si as a nature of glass material—has a low Si-content not greater than half of that of glass substrates 4 and 90. Glass substrates 4 and 90, which contain Si as a main component, usually have an Si-content ranging from 20 wt % to 30 wt %. The low Si-content of insulating layer 11 contributes to a minimized Si-dispersion into sealing member 16. According to the PDP of the embodiment, insulating layer 11 has a thickness ranging from 5 μm to 20 μm, and protection layer 98 has a thickness ranging from 0.5 μm to 2 μm. Having a proper thickness may be an advantageous factor.

According to the PDP of the embodiment, as described above, the reinforced sealing section allows the flat display to have high reliability. Besides, in the embodiment, protection layer 98 and insulating layer 11, both of which constitutes the PDP, serve as an intermediate layer to prevent Si-dispersion into the interface between sealing member 16 and glass substrates 4, 90. That is, there is no need to have another step for forming the intermediate layer, simplifying the manufacturing process. When an intermediate layer is additionally disposed between sealing member 16 and glass substrates 4, 90, the following are important in designing the layer from the aforementioned analysis;
the intermediate layer has a silicon-content lower than the glass substrates; and
the intermediate layer has a thickness of at least 0.1 μm (100 nm).

### Second Exemplary Embodiment

Next will be described the structure in accordance with the second exemplary embodiment.

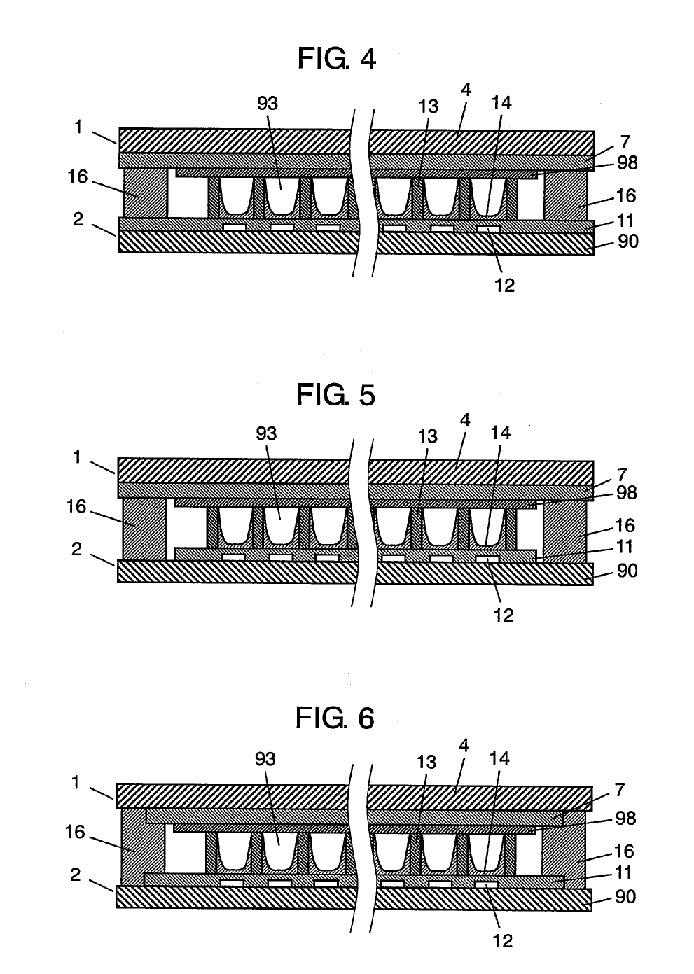

FIG. 4 is a section view showing the essential part of the structure of a PDP as a flat display in accordance with the embodiment. The PDP of the second embodiment differs from that of the first embodiment in that protection layer 98 does not extend inside peripheral section 15 on which sealing member 16 is applied, as shown in FIG. 4. At the interface between glass substrate 4 of front substrate 1 and sealing member 16, dielectric layer 7 is disposed as an intermediate layer. At the interface between glass substrate 90 of back substrate 2 and sealing member 16, insulating layer 11 is disposed as an intermediate layer.

The PDP of the second embodiment also underwent the drop impact test as with the case in the first embodiment. According to the test result, no problem occurred in sealing member 16 in the PDPs. The inventor observed each interface between sealing member 16 and dielectric layer 17, and between sealing member 16 and insulating layer 11 to check for Si-dispersion into sealing member 16. The result showed that the both side of sealing member 16 had Si-dispersion of not more than 10 nm. Although dielectric layer 7 is made of glass and therefore contains Si, the Si-content of the layer is lower than half that of a glass substrate predominantly composed of Si. It is conceivable that the low content of Si contributes to less Si-dispersion into sealing member 16. In the PDP of the second embodiment, as shown in FIG. 4, dielectric layer 7 and insulating layer 11 can be a multi-layered structure having different composition. In this case, to minimize the Si-dispersion, the layer arrangement should be determined in a manner that a layer with a lower Si-content is located closer to sealing member 16. Employing the structure above allows a flat display to have a reinforced sealing section, providing performance with high reliability.

### Third Exemplary Embodiment

FIG. 5 is a section view showing the essential part of the structure of a

PDP as a flat display in accordance with the third exemplary embodiment. The PDP of the third embodiment differs from that of the first embodiment in that protection layer 98 and dielectric layer 11 do not extend inside peripheral section 15 on which sealing member 16 is applied, as shown in FIG. 5. At the interface between glass substrate 4 of front substrate 1 and sealing member 16, dielectric layer 7 is disposed as an intermediate layer. That is, the intermediate layer is formed on at least one of the interfaces between glass substrate 4 and sealing member 16, and between glass substrate 90 and sealing member 16.

The PDP of the third embodiment also underwent the drop impact test as with the case in the first embodiment. According to the test result, the strength of the PDP proved somewhat inferior to that of the first embodiment; one or two defective PDPs were found in ten thousand PDPs in an actual transportation test. In conclusion, it satisfactorily maintains a proper level in practical use.

### Fourth Exemplary Embodiment

FIG. 6 is a section view showing the essential part of the structure of a PDP as a flat display in accordance with the fourth exemplary embodiment. The PDP of the fourth embodiment differs from that of the first embodiment in that dielectric layer 7 and insulating layer 11 extend inside peripheral section 15 on which sealing member 16 is applied so as to exceed 50% of the section. The PDP of the fourth embodiment also underwent the drop impact test as with the case in the first embodiment. The test result showed that such structured PDP—where the area of dielectric layer 7 and insulating layer 11 in peripheral section 15 exceeds 50% of the total area of peripheral section 15 (as a total area of each peripheral section of front substrate 1 and back substrate 2)—had substantially no problem in the actual transportation test. The inventor has a conclusion that dielectric layer 7, insulating layer 11 and sealing member 16 disposed between glass substrates 4 and 90 of the PDP structured above maintain a bonding strength at a satisfactory level.

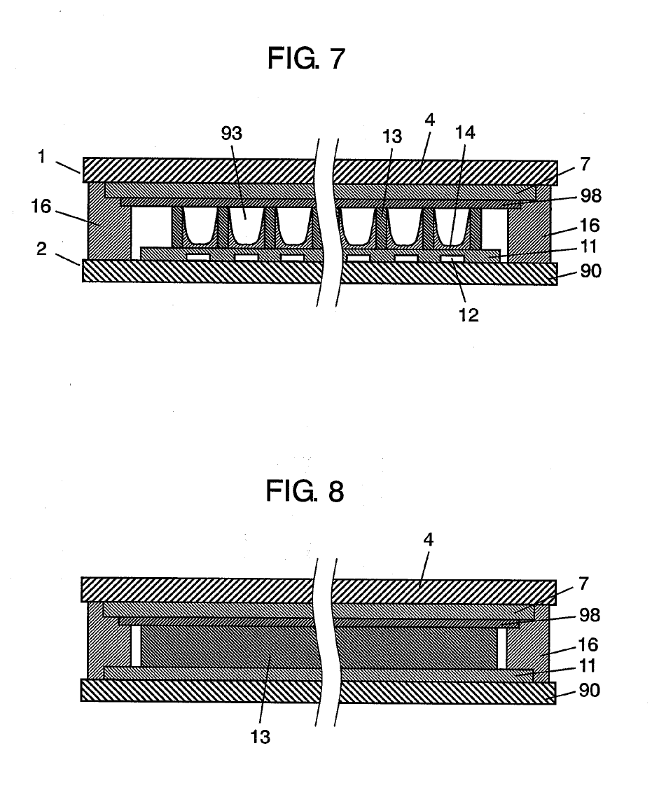

FIG. 7 is a section view showing the essential part of another structure of a PDP as a flat display in accordance with the fourth exemplary embodiment. FIG. 8 is a section view along the line 8-8 in FIG. 2, showing the essential part of still another structure of a PDP as a flat display in accordance with the fourth exemplary embodiment. For convenience sake, scan electrodes 5, sustain electrodes 6 and shielding layer 9 are omitted from the drawings above. The distinctive feature of the PDP shown in FIG. 7 is that dielectric layer 7 as an intermediate layer is formed on peripheral section 15 on glass substrate 4 so as to exceed 50% of peripheral section 15 on which sealing member 16 is applied; and at the same time, protection layer 98 as an intermediate layer is formed on peripheral section 15 on glass substrate 4 so as to extend inside peripheral section 15 on which sealing member 16 is applied.

The distinctive feature of still another PDP is that, as is in FIG. 8 that shows a section taken along the line 8-8 in FIG. 2, dielectric layer 7 and insulating layer 11 as an intermediate layer are formed on peripheral section 15 on glass substrates 4, 90 so as to exceed 50% of peripheral section 15 on which sealing member 16 is applied; and at the same time, protection layer 98 as an intermediate layer is formed on peripheral section 15 on glass substrate 4 so as to extend inside peripheral section 15 on which sealing member 16 is applied. The inventor has a conclusion that dielectric layer 7, insulating layer 11 and sealing member 16 disposed between glass substrates 4 and 90 of the PDP structured above maintain a bonding strength at a satisfactory level. As a result of the drop impact test on the PDP structured above, the structure achieved a satisfactory bonding strength in an actual transportation test as the practical use.

### Fifth Exemplary Embodiment

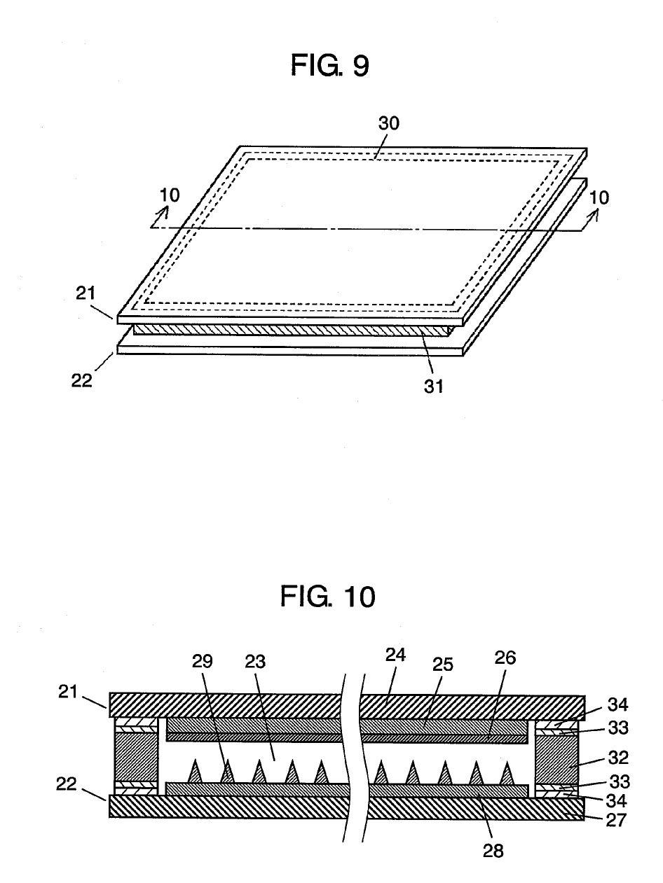

Here in the embodiment, a display device employing an electron-emitting element will be described as a flat display of the fifth exemplary embodiment. FIG. 9 is a perspective view showing an appearance of a display device employing an electron-emitting element. FIG. 10 is a section view, taken along the line 10-10 in FIG. 9, showing the essential part of the structure of the display device employing an electron-emitting element.

In the display device employing the electron-emitting element, as is shown in FIGS. 9 and 10, front substrate 21 and back substrate 22, both of which are made of glass, are oppositely disposed via vacuum space 23 therebetween. Front substrate 21 has glass substrate 24; anode electrode 25 laid over glass substrate 24; and phosphor layer 26 laid over anode electrode 25. Anode electrode 25 is made of a transparent conductive film, such as an ITO-film and an SnO₂-film. On the other hand, back substrate 22 has glass substrate 27 and cathode electrode 28 on glass substrate 27. Cathode electrode 28 is made of a metallic thin film. On cathode electrode 28, electron-emitting element array 29 is formed. FIG. 10 shows an example where the structure employs a spint-type cold cathode. Front substrate 21 and back substrate 22 are oppositely located and bonded with each other at sealing section 31 on peripheral section 30 of the structure. Sealing section 31 has frame 32 that is made of glass material having a characteristics the same as the glass substrate. Frame 32 keeps a distance of a few millimeters between front substrate 21 and back substrate 22. Further, sealing member 33 containing Bi is formed between frame 32 and each of glass substrates 24 and 27.

In a display device employing an electron-emitting element, intermediate layer 34 is formed at least between sealing member 33 and glass substrates 24, 27. Intermediate layer 34 is made of low-melting glass. Intermediate layer 34 has an Si-content lower than glass substrates 24, 27 and a thickness of 0.1 μm or greater.

For comparison purposes, the inventor prepared display devices employing an electron-emitting element shown in FIG. 9 with no intermediate layer 34, and carried out the drop impact test, as with in the first exemplary embodiment. The result showed that some samples had a crack between sealing member 33 and glass substrate 24 or glass substrate 27 and by which leak occurred. In contrast, the display devices employing an electron-emitting element of the fifth embodiment had no leak.

Forming intermediate layer 34 between frame 32 and sealing member 33 enhances bonding strength of sealing section 31.

The cold cathode method and the structure of a display device above are described by way of example and without limitation; the present invention is also applicable to a display device having a grid electrode.

As described above, the flat display of the present invention has a sealing section with reinforced bonding strength, providing the structure with high reliability.

### INDUSTRIAL APPLICABILITY

The present invention enhances reliability of a flat display.

1. A flat display comprising:
a pair of silicon-contained glass substrates oppositely disposed at intervals therebetween; and
a bismuth-contained sealing member disposed on a periphery of the pair of glass substrates,
wherein, an intermediate layer whose silicon-content is lower than that of the glass substrate is disposed at an interface between the glass substrates and the sealing member.

2. A flat display comprising:
a front substrate further including:
a glass substrate on which display electrodes are formed;
a dielectric layer disposed on the glass substrate so as to cover the display electrodes; and
a protection layer disposed on the dielectric layer; and
a back substrate disposed opposite to the front substrate, the back substrate further including:
a glass substrate to be paired with the glass substrate of the front substrate;
an data electrode disposed on the glass substrate; and
an insulating layer that covers the data electrodes; and
a bismuth-contained sealing member for sealing a periphery of the front substrate and the back substrate,
wherein, an intermediate layer whose silicon-content is lower than that of the glass substrates is disposed at an interface between the glass substrates and the sealing member.

3. The flat display of claim 1, wherein the intermediate layer has a thickness of at least 0.1 μm.

4. The flat display of claim 1, wherein the intermediate layer is formed on an entire surface of the glass substrates.

5. The flat display of claim 1 wherein the intermediate layer is formed on the glass substrates so as to occupy at least 50% of an area where the sealing member is applied.

6. The flat display of claim 1, wherein the intermediate layer is made of a glass with a low melting point or a crystalline oxide film.

7. The flat display of claim 1, wherein the intermediate layer is made of a glass with a low melting point and has a silicon-content not greater than half of that of the glass substrates.

8. The flat display of claim 1, wherein the sealing member contains bismuth as a main component.

9. The flat display of claim 1, wherein the intermediate layer is formed on at least one of two interfaces between the sealing member and the pair of glass substrates.

10. The flat display of claim 2, wherein the intermediate layer is the dielectric layer or the protection layer of the front substrate.

11. The flat display of claim 2, wherein the intermediate layer is the insulating layer of the back substrate.

12. The flat display of claim 2, wherein the intermediate layer has a thickness of at least 0.1 μm.

13. The flat display of claim 2, wherein the intermediate layer is formed on an entire surface of the glass substrates.

14. The flat display of claim 2 wherein the intermediate layer is formed on the glass substrates so as to occupy at least 50% of an area where the sealing member is applied.

15. The flat display of claim 2, wherein the intermediate layer is made of a glass with a low melting point or a crystalline oxide film.

16. The flat display of claim 2, wherein the intermediate layer is made of a glass with a low melting point and has a silicon-content not greater than half of that of the glass substrates.

17. The flat display of claim 2, wherein the sealing member contains bismuth as a main component.

18. The flat display of claim 2, wherein the intermediate layer is formed on at least one of two interfaces between the sealing member and the pair of glass substrates.
